(19) United States
(12) Patent Application Publication
(10) Pub. No.: US 2009/0265747 A1
(43) Pub. Date: Oct. 22, 2009

(54) SYSTEMS AND METHODS FOR PROVIDING WEB BASED SELF SERVICED VIDEO MONITORING AND SECURITY FEATURES FOR SYSTEMS COMPRISING IP VIDEO TERMINALS AND SERVERS

(75) Inventor: Matt Ming LI, Richmond (CA)

Correspondence Address: NEXUS LAW GROUP LLP, 1500 - 701 WEST GEORGIA STREET, VANCOUVER, BC, V7Y 1C6, CA

(73) Assignee: Canada ANV Systems Inc., Richmond (CA)

(21) Appl. No.: 12/405,147

(22) Filed: Mar. 16, 2009

Related U.S. Application Data
(60) Provisional application No. 61/037,197, filed on Mar. 17, 2008.

(51) Int. Cl. H04N 7/173; H04N 7/18; G06F 17/30

(52) U.S. Cl. 725/109; 725/115; 348/143; 725/116; 348/E07.085; 707/10; 707/E17.01

(57) ABSTRACT

A video security system having a server and a video terminal device includes: at least one database for storing network and physical configuration information relating to the terminal device operable to remotely communicate with the server through a distributed network; and one or multiple storage servers for storing video data received from the terminal devices.

A method of managing a video terminal device involves: assigning a unique device ID to the video terminal device; sending an event and an associated video stream from the video terminal device to the Server; and storing the event and the associated video stream into a database and a storage server in association with the unique device ID.

Another method involves: creating a user account on a Server; selecting services for associating with the devices; allocating storage server space for storing video data stream files; and making available to the user stored video files.

### FIELD OF INVENTION

The field of this invention is apparatus, systems and methods for providing web based video monitoring and security features through systems that comprise video terminals and servers.

### BACKGROUND

The following publications may be relevant and their content is hereby incorporated herein by reference: U.S. Pat. No. 7,124,427: Method and apparatus for surveillance using an image server; U.S. Pat. No. 7,034,681: Home security video system using internet technique; U.S. Pat. No. 6,956,599: Remote monitoring apparatus using a mobile videophone; U.S. Pat. No. 6,771,741: Surveillance arrangement and controller; U.S. Pat. No. 6,400,903: Remote camera relay controller method and apparatus; U.S. Pat. No. 6,400,265: System and method for monitoring security systems by using video images.

### SUMMARY OF EMBODIMENTS

In embodiments the video terminal device may be assigned a unique device ID. The device ID may be used to register to a server. The server may be a web server. A user with a valid device ID may sign up to the server and create his own account and password upon correct input the device ID. The user may set up his own preferred services and gains full control of the video terminal devices through the Server, the functions available through the Server may include the video sequence storing, processing, downloading, viewing, devices adding, deleting and transferring, events notification through various media devices including message and voice services and so on. The Server may be remotely located and secured. The storage servers may be either collocated or remote from the Server. The terminal devices, the Server and the storage servers may work in parallel to provide a fully scalable and easy to install and use system for the end users.

In embodiments systems and methods are provided for allowing the video terminal devices to register to a Server. The systems and methods include assigning the unique device ID to each video terminal device. For security purposes, the video terminal device ID may be encrypted in the messages sent and received between the video devices and the Server.

In embodiments the video terminal device may report the IP address and video stream communication port information to the registered server during the device registration process. The video terminal device user, who is usually the owner or system administrator of the device, may sign up with the server with an account and password combination. During the sign up process, the user has to provide the Server with the device ID. With the previously signed up account and password name, the user can log in to the Server and starts viewing the video through the terminal devices. The video terminal devices can also be configured to send the compressed video stream to the Server when an external event is triggered. The external event may be a pre-configured condition such as a sensor is closed or the motion in the video is detected. Once the recorded video and the external events are sent to the Server, the Server may send out a notice to the user account that is associated with the terminal devices. The Server may also provide the billing functions to allow the user to choose to pay for a range of different services. The services may include the extra video storage space and larger volume of mobile messaging services (such as short message services, SMS, or WAP push services etc). Thus the system becomes a fully self-serviced system that allows the user to manage the ownership and defines the usage (user profile) of the devices and avoid substantial amount of system administration work by using the Server functions. In embodiments servers may be web servers.

As a result of the disclosed systems and methods, the video terminal device user may get a system notification when the event occurs and the user can log in to the system and download the stored video sequence file sent from the video terminal device that has been stored on the Server. In embodiments the disclosed systems, methods and apparatuses may provide a flexible way of deploying and managing the video devices and easier use and access of the video terminal devices and better protection of the recorded video sequence.

In a first embodiment, there is disclosed a video security system that may comprise a server and a video terminal device, the video terminal device suitable for remote communication with the server. The system may further comprise at least one database for storing configuration information relating to the terminal device; and a security feature for allowing the video terminal device to communicate with the server through a distributed network; and a storage server for storing the video data sent from the video terminal devices.

In alternative embodiments, there is disclosed a method in a video monitoring and security system for allowing a user to manage one or multiple video terminal devices. The method may comprise assigning a unique device ID to the video terminal device, the terminal device registers to a server and the server verifies validity of the device ID by checking a database that contains all valid devices stored in the database; and allowing the video terminal device to send an event associated video stream to the server and stores the events and the associated video stream into a separate database and a storage server, which are searchable and indexed through the unique device ID.

In alternative embodiments, there is disclosed a method in a video monitoring and security system for allowing a user to manage one or multiple video terminal devices. The method may comprise allowing a user to create a user account on a server and the user is allowed to add, delete, transfer and view the devices once the user login to the server; and allowing the user to manage a user's profile to select services to associate with the devices and the individual services also specify different means of handling of events; and allocating storage server space for the devices owned by the user to store video data stream files and the users are allowed to retrieve the stored video files.

Features and advantages of the subject matter disclosed will become more apparent in light of the following detailed description of some embodiments thereof, as illustrated in the accompanying figures. As will be realized, the various embodiments are capable of modifications in various respects and may be combined in a variety of alternative ways, all without departing from the spirit and scope of the claims. Accordingly, the drawings and the description are to be regarded as illustrative in nature, and not as restrictive.

### BRIEF DESCRIPTION OF THE DRAWINGS

The accompanying drawings, which are incorporated in and form a part of the specification, illustrate alternative embodiments

FIG. 1 illustrates a device registration process, device configuration reporting (with a unique device ID);

FIG. 2 illustrates an embodiment of rendering the device configuration to the device user on the user graphic interface;

FIG. 3 illustrates an embodiment of triggering of an external event;

FIG. 4 illustrates an embodiment of the video capturing and compressed video transmitting to the Server;

FIG. 5 illustrates an embodiment of the user account sign up process;

FIG. 6 illustrates an embodiment of rendering the device ID for the device user to input on the user graphic interface;

FIG. 7 illustrates an embodiment of the user profile management process;

FIG. 8 illustrates an embodiment of rendering the user profile to the device user on the user graphic interface;

FIG. 9 illustrates an embodiment of the device management (monitoring, media files retrieving, add/delete/transfer of the video devices) process;

FIG. 10 illustrates an embodiment of rendering the device management operations to the device user on the user graphic interface; and

FIG. 11 illustrates an embodiment of the event notification process.

### DETAILED DESCRIPTION

### Definitions

In this disclosure a “server” may be any type of server, or any equivalent device useable for the purposes set out herein, and in embodiments may be a web server and in embodiments may include a storage server. A server may comprise one or more databases.

In this disclosure a “database” means any facility for the storage of data, (including all forms of data, information, images and the like), and may include or be coterminous with or the same thing as or part of the same apparatus as or overlap with a storage server or server. One or more databases may be comprised in particular embodiments.

In this disclosure “video” refers to the ability to collect and/or to use optical data or data derived from the reception of electromagnetic radiation of any kind including infra red and ultraviolet radiation whether or not such radiation falls within the visible spectrum. “video terminal device” refers to any form of apparatus able to acquire and convert into transmissible form an image created by electromagnetic or ultrasonic information of any kind and includes cameras.

Without limiting the foregoing, all terms used herein shall have a least their broadest possible ordinary meaning.

Reference is made in detail to alternative embodiments, non-limiting embodiments of which are illustrated in the accompanying drawings. The subject matter hereof is described to illustrate embodiments which may be or may comprise apparatus, systems, methods, and software.

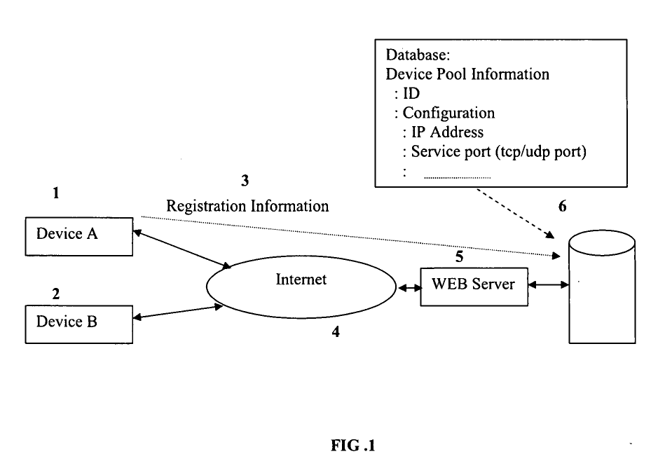

FIG. 1 provides an embodiment of the devices registering to the Server. The video devices illustrated as 1 and 2 are each assigned a unique device ID. The devices send registration messages 3 over Internet 4.

The registration messages 3 contain the encrypted device ID and the devices configuration information to the Server 5. Different encryption methods can be chosen per the specific system needs. For example, the AES algorithm can be used to encrypt the device ID and one or many segments of the messages. Depending on the system complexity and security level, a typical implementation of the AES algorithm can be done in software or hardware. The Server 5 receives the registration messages 3 and decrypts the devices ID or other segments of the registration messages 3 and stores the devices information into the database 6. The Server 5 stored a list of devices that are allowed to register to the Server. If the device is not in the list, the registration messages 3 are rejected, and the device information is not stored in the database 6. The database 6 contains information for a pool of devices such as 1,2, each device is uniquely identified through its device ID and indexed into the device configuration information including IP address, service port (TCP and UDP), bandwidth available to the devices, current traffic load information and so on.

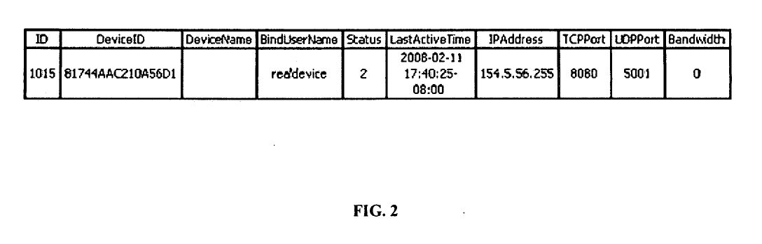

FIG. 2 provides an exemplary rendering of the devices configuration information to the Server user on the user graphical interface (GUI), such as a WEB browser.

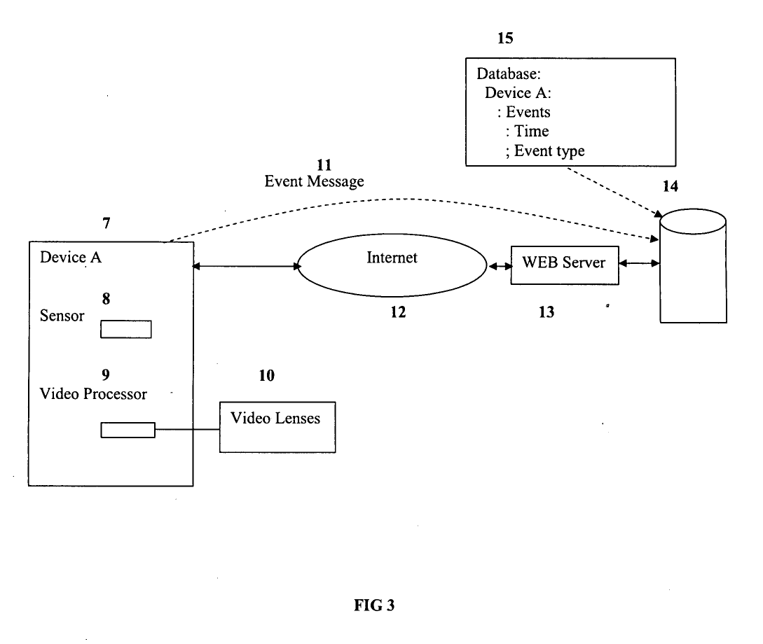

FIG. 3 provides an embodiment of the video terminal device 7 is triggered by an external event and sends out the event through an event message 11 carried over the Internet 12 to the Server 13. The video terminal devices intended to use for security and monitoring purposes usually have built-in sensors 8 or video processors converting analog luminance and chrominance into digital video signals. The sensors may include infrared, light, distance, pressure, gas, liquid, carbon monoxide, RADAR, thermal and electrical sensors. The analog signal is usually fed from image sensors receiving beam light that is focused from external video lenses 10. In particular embodiments the external event may be a built in sensor 8, such as an infrared sensor, detects an intrusion of the protected area, or the built in video processor detects motion content in the video signal for the monitored area or may be an alarm or a door or window or opening or a motion detector, a tripwire, a temperature or humidity or other sensor, a light detector, a weight sensitive sensor, a noise detector, or any form of sensor whatsoever, with the appropriate sensor type and properties being readily identified by those skilled in the art. The event messages 11 are received on the Server 13; the event details are extracted by the Server and stored in the database 14. The event details 15 are associated with the device that sends out the event. The event details may include the time of triggering of the external event, the event type, such as an infrared sensor type or the video motion content type and so on. The event details 15 indexed through the devices' ID.

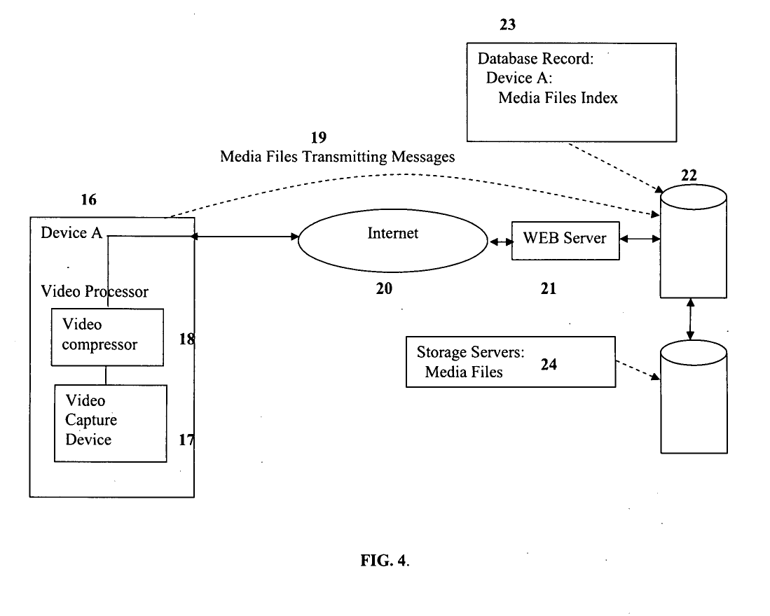

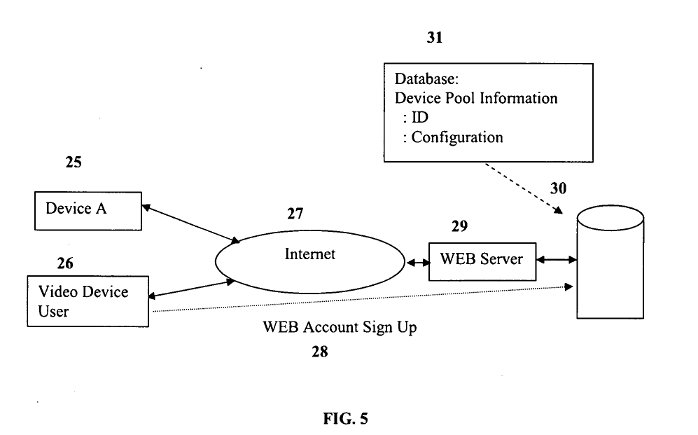

FIG. 4 provides an embodiment of the video capturing, compressing and transmitting process. When an external event is triggered on the video device 16, the video processor comprising the video capturing device 17 and the video compressor 18 begins working. The video capturing device converts the video signal into frames of video data. The video frames usually generate large volume data and consume too much bandwidth to be transmitted over the Internet 20. The video frame data is sent to the video compressor 18. The video frame data is compressed and reframed into lower bandwidth data and sent to the Server 21 through specific media file transferring messages. The Server extracts the compressed video frame data and stores into the storage servers 24. There can be as many storage servers 24 as needed in the system to accommodate geographically distributed video devices 16, the storage servers 24 are deployed to minimize the data transit delay and data loss between the video devices 16 and the storage servers 24. The compressed video frame data is reformatted and saved as individual media files corresponding to different events. The database 22 contains the record 23 associated with the device 16 and the media file—associated with the storage server 24 that is triggered by the specific event.

FIG. 5 shows an embodiment of the video device user 26 signing up an account with the Server 29. As illustrated in FIG. 1, the device 25 is assigned a unique device ID. The user 26 sends a web account sign up request 28 to the WEB user over the Internet 27. The request 28 contains the encrypted device ID and the device 25 is registered with the Server 29 successfully. The Server 29 checks the database to verify the device ID is stored as an effective record 31 in the database. The device record 31 contains the device ID and configuration information as illustrated in FIG. 1. If the device ID sent from the user is verified to be an effective device ID, the user is prompted to proceed with creating his own account and password name.

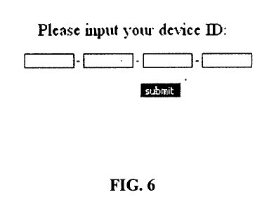

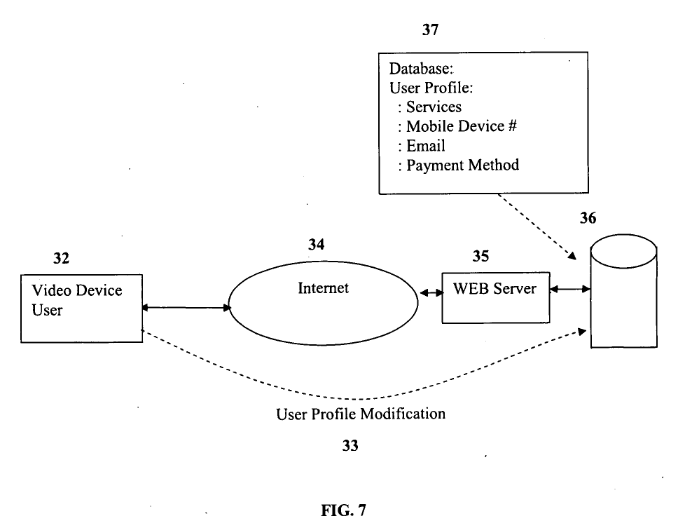

FIG. 6 provides an exemplary implementation that user is prompted to type in the device ID on the user graphical interface (GUI), such as a WEB browser.

FIG. 7 provides an embodiment of the video device user 32 modifying the user profile by sending a User Profile Modification request 33 to the Server 35 over the Internet 34. The Server 35 receives the request. The request contains the user's account name and password, which may be encrypted. The Server 35 authenticates the user's credential. If the user 32 passed the authentication, then the user 32 is allowed to access the profile management function of the Server 35. In a typical implementation, the user has to log in to the system and type in the user account name and password that has been set up in the process illustrated in FIG. 5. The profile management includes adding, removal and modification to the user's profile. The user's profile information is stored as a record 37 in the database 36. The database record for the user contains the services that the user subscribes to, the mobile device (such as a mobile telephone) number, the email contact information, the payment method and so on. The services may include the short messages service, email or voice notification of the events triggered on the video device, wireless application protocol (WAP) services. For a paid system, the services can be defined as either prepayment account or recurring payment account to allow billing of the user accounts.

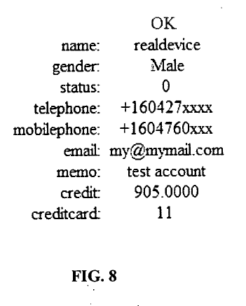

FIG. 8 provides an exemplary implementation that the user is prompted to modify the user profile on the user graphical interface (GUI), such as a WEB browser.

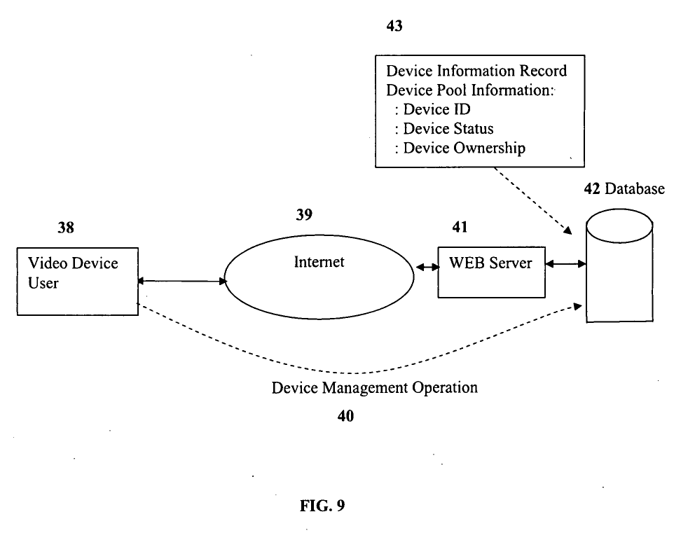

FIG. 9 provides an embodiment of the video device user 38 managing the devices by sending a Device Management Operation request 40 to the Server 41 over the Internet 39. In a typical implementation, the user has to log in to the system and type in the user account name and password that has been set up in the process illustrated in FIG. 5. The credential of the user 38 has to be authenticated by the WEB sever 41. Once the authentication has passed, the user is allowed to access the device management functions that are provided by the Server 41. The devices information is stored on the database 42. Each device information record 43 contains the devices pool information including the device ID, the device status and device ownership. The device status indicates the state of the device, which may indicate whether the device is a validly registered device, a validly registered but not-connected to the Server, or a device that has expired and so on. The ownership corresponds to an account that is registered with the Server 41. If the user has the right account and password to sign in to the Server, then the user owns the device for the entire login period. The device management function includes adding, removing, transferring of the device. The adding device operation requires the user to input the device ID that is added under the ownership of the user. The removing operation requires the user to input the device ID that is removed under the ownership of the user. Once the device has been removed from the user's ownership, another user can take the ownership of the device. The transferring operation requires the user to input another user's account ID. The Server 41 verifies the ownership of the device is under the transferring user and the user that is taking the ownership has a valid account on the system, the user that is taking the ownership can manage the added device.

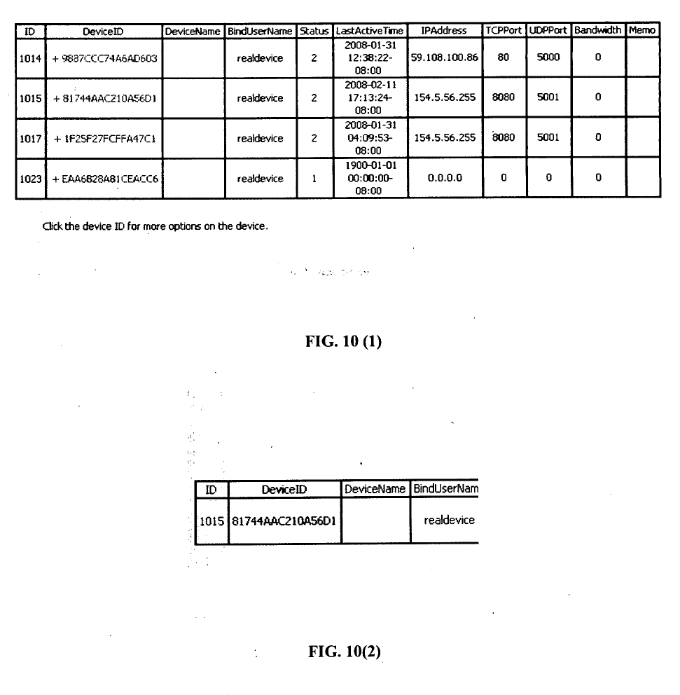

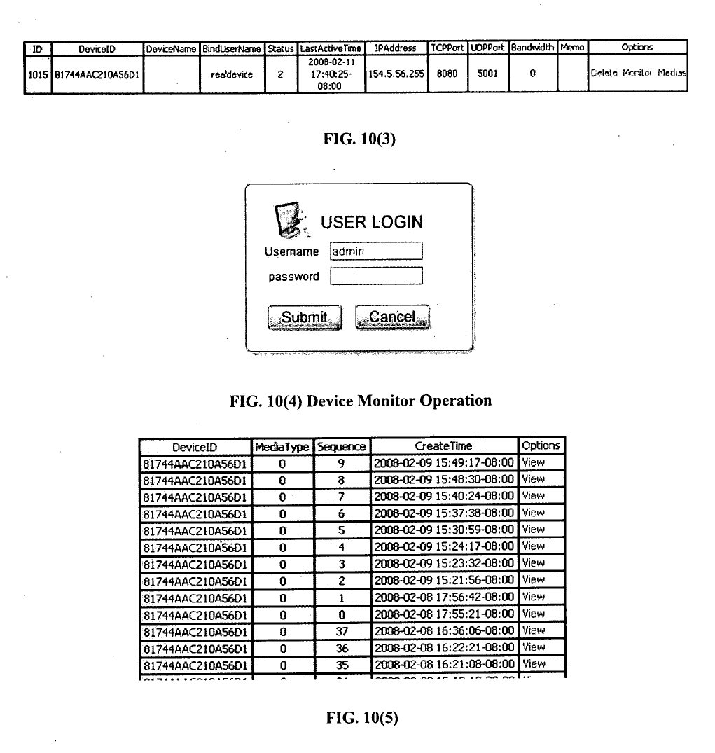

FIG. 10 (1) provides an exemplary implementation that the device user owns a few devices and the user can also click the “Add a new device” button to add a new device. FIG. 10(2) provides an exemplary implementation that the device user is prompted to click the “Transfer this device” button to transfer the ownership of the device. FIG. 10(3) provides an exemplary implementation that the device user can click the “Delete Monitor Medias” button to continue the device deleting, device monitoring and media files reviewing operations. The device deleting operations takes the ownership of the device away from the user. The monitoring process prompts the user to login to the monitored device as illustrated in FIG. 10(4). The media files operation prompts the user to select a previously uploaded media file for download and review by using a media player. FIG. 10(5) gives an embodiment of media files list sent by the device 81744AAC210A56D1.

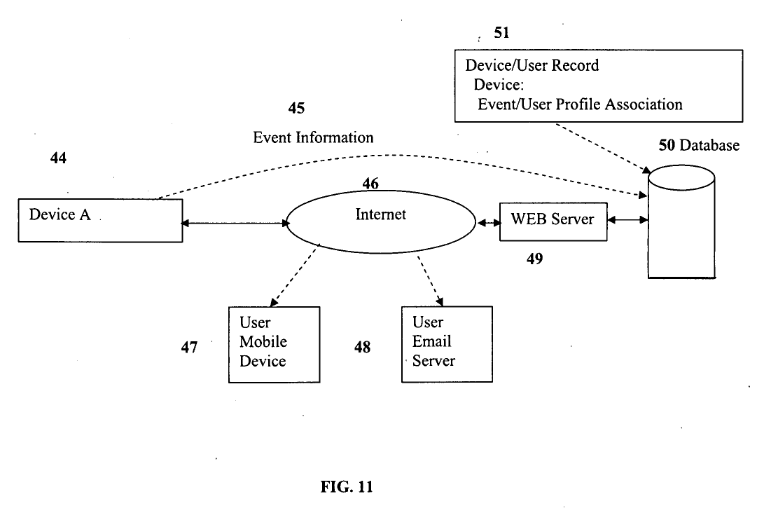

FIG. 11 provides an exemplary implementation of event notification mechanism. The device 44 sends an event notification message 45 to the Server 49 over the Internet 46. This event triggering process is detailed in FIG. 3. Once the Server receives the event message 45, the Server 49 associates the device ID with the User Profile by checking the device/user record 51 in the database 50. If the user profiles shows that the user has a preference to forward the event, which may also include part of the media file, to the user mobile device 47, the Server 49 then forwards the event to the user mobile device 47. If the user also prefers an Email notification, the Server 49 also forwards the event to the email server 48 that the user subscribes to.

In embodiments the particular forms of linkage between different components of the apparatuses described may comprise any conventional medium including hard wired, wireless, optical cable or other means of signal transmission. Similarly particular components may be collocated or remote from each other. In embodiments users may use the apparatus through any type of suitable device which may include computer terminals, laptops, handheld communication devices, mobile telephones, and may use Bluetooth, cellular phone, satellite or other communication systems. Systems set out herein may operate through the internet or through local networks. The properties of any video devices and any sensors and the selection thereof for particular applications will be readily apparent to those skilled in the art.

The embodiments and examples presented herein are illustrative of the general nature of the subject matter claimed and are not limiting. It will be understood by those skilled in the art how these embodiments can be readily modified and/or adapted for various applications and in various ways without departing from the spirit and scope of the subject matter disclosed claimed. The claims hereof are to be understood to include without limitation all alternative embodiments and equivalents of the subject matter hereof. Phrases, words and terms employed herein are illustrative and are not limiting. Where permissible by law, all references cited herein are incorporated by reference in their entirety. It will be appreciated that any aspects of the different embodiments disclosed herein may be combined in a range of possible alternative embodiments, and alternative combinations of features, all of which varied combinations of features are to be understood to form a part of the subject matter claimed.

We claim:

1. A video security system comprising a server and a video terminal device, said video terminal device suitable for remote communication with said server, said system further comprising:
a) at least one database for storing network and physical configuration information relating to said terminal device; and
b) a security feature for allowing said video terminal device to communicate with said server through a distributed network; and
c) one or multiple storage servers for storing the video data sent from the said video terminal devices.

2. The system according to claim 1, wherein said video terminal device comprises a sensor and a video processor.

3. The system according to claim 2, wherein said database is suitable for storing said configuration information associated with said devices, the said configuration information maps said devices to said storage servers.

4. The system according to claim 3, wherein said storage server stores said video data at a location remote from said video terminal device, the said data.

5. The system according to claim 4, wherein said sensor or captured video is the trigger source of said terminal device.

6. The system according to any one of claims 1 through 5 wherein said distributed network is the Internet.

7. A method in a video monitoring and security system for allowing a user to manage one or multiple video terminal devices, comprising:
a) assigning a unique device ID to said video terminal device, said terminal device registers to a Server and said Server verifies validity of said device ID by checking a database that contains all valid devices stored in said database; and
b) allowing said video terminal device to send an event associated video stream to said Server and stores said events and said associated video stream into a separate database and a storage server, which are searchable and indexed through said unique device ID.

8. The method of claim 7, wherein said device ID reported to said Server is encrypted before it is sent to said Server and said Server receives said device ID after decrypting a message.

9. The method of claim 7, wherein said video terminal devices are installed with sensors or video processor which employs motion detection function.

10. The method of claim 7, wherein said events include information stored on said database and said events recorded on said database are searchable and indexed through said device ID.

11. The method of claim 10, said information comprises a event type, a motion content type and the time occurred.

12. The method of claim 7, wherein said video devices comprise video capturing and compressing components that are triggered by the event and send said device ID along with compressed video data to said WEB serve and said Server verifies the validity of said device before it stores the compressed video data.

13. The method of claim 7, further comprising:
said devices report a device configuration information to said Server and allow said devices to be remotely connected and viewed.

14. A method in a video monitoring and security system for allowing a user to manage one or multiple video terminal devices, comprising:
a) allowing a user to create a user account on a Server and said user is allowed to add, delete, transfer and view said devices once said user login to said Server; and
b) allowing said user to manage a user's profile to select services to associate with said devices and said individual services also specify different means of handling of events; and
c) allocating storage server space for said devices, owned by said user, to store video data stream files and said users are allowed to retrieve said stored video files.

15. The method of claim 14, wherein said user is required to input a device ID to set up an account with said Server.

16. The method of claim 14, wherein said user is allowed to download or playback previously stored video stream files indexed through said devices ID.

17. The method of claim 14, further comprising:
said user is allowed to transfer the ownership of one or more said devices to another signed up account and said user is also allowed to add and delete said devices from a device list of accounts and said devices operations are fulfilled through adding, deleting and transferring transactions sent to said database.

18. The method of claim 14, further comprising:
said user's profile specifies user's information and services subscribed by said user and
said user's profile is associated with said events and user can receive an event notification through different means.

19. The method of claim 17, wherein said means comprises WAP, SMS, e-mail, voice.
